(19) United States
(12) Patent Application Publication
(10) Pub. No.: US 2002/0088653 A1
(43) Pub. Date: Jul. 11, 2002

(54) Electric vehicle and method of keeping the electric vehicle at stopping position

(75) Inventors: Yuusuke Takamoto, Hitachinaka-shi (JP); Ryoso Masaki, Hitachi-shi (JP)

Correspondence Address: CROWELL & MORING, L.L.P., P.O. Box 14300, Washington, DC, 20044-4300, US

(73) Assignee: Hitachi Ltd.

(21) Appl. No.: 10/091,493

(22) Filed: Mar. 7, 2002

Related U.S. Application Data
(63) Continuation of application No. 09/166,570, filed on Oct. 6, 1998, now abandoned.

(30) Foreign Application Priority Data
Oct. 6, 1997 (JP) 9-272965

(51) Int. Cl. B60K 1/00

(52) U.S. Cl. 180/65.1

(57) ABSTRACT

An electric vehicle is provided. The electric vehicle can minimize required energy based on position control for keeping the electric vehicle not being moved downward on a sloping road when a driver steps on the brake pedal even if the brake force is weak.

The electric vehicle keeps a vehicle body at a stopping position using rotating torque of an electric motor for driving the vehicle body to run, wherein the rotating torque is calculated corresponding to an operated quantity of brake operation, and when the brake pedal is stepped on under a condition that the vehicle body is at a stopping position by the rotating torque of the electric motor, the rotating torque is decreased and a quantity of downward motion of the electric vehicle is measured, and the electric vehicle is again brought at the stopping position by the rotating torque when the quantity of downward motion of the electric vehicle exceeds a preset value.

### BACKGROUND OF THE INVENTION

The present invention relates to an electric vehicle and a method of keeping the electric vehicle at a stopping position and particularly to an electric vehicle which minimizes required energy for keeping the vehicle body at a stopping position on a sloping road using rotating torque of an electric motor and a method of keeping the electric vehicle at a stopping position.

As a stopping means for an electric vehicle, it has been known that braking torque is generated by a drive motor to assist in keeping the vehicle at a stopping position, and when the vehicle is stopping on a sloping road, the braking torque is always generated to assist a braking means in preventing the vehicle from moving downward on the sloping road. In this technology, when the electric vehicle is stopped on the sloping road, a driver has to apply mechanical breaking force to the vehicle using the braking means.

In order to solve the above-described problem, Japanese Patent Application Laid-Open No. 5-268704 proposes a technology which is capable of keeping an electric vehicle at a stopping position without mechanical braking force using a brake by performing position control taking a stopping position of the vehicle as a target position to keep the stopping position using motor torque when the vehicle is stopped on a sloping road.

Further, Japanese Patent Application Laid-Open No. 7-322404 proposes a means for correcting output torque of a driving motor in an electric vehicle so as to generate torque against moving downward of the vehicle under a condition that neither the accelerator pedal nor the brake petal is stepped on. According to the means, it is possible to easily perform starting and very slow running on a sloping road, and also to improve drivability of very slow running on a flat road.

Furthermore, in an electric vehicle using a synchronous motor for the driving motor, Japanese Patent Application Laid-Open No. 7-336807 proposes a means which limits backward running speed at performing decreasing control of a torque command value for protecting the motor when a driver is adjusting an accelerator to generate motor torque to such a degree that the electric vehicle is not moved backward on an ascending road, and performs torque decreasing control only when a stall state is continued exceeding an allowable period. According to the means, it is possible to prevent the driving motor and the other electric power circuits from occurring substantial local heat generation, and to eliminate sudden backward moving of the electric vehicle, and to prevent the torque decreasing control from being performed to cause backward moving of the electric vehicle regardless of such a short period that the local heat generation becomes a problem.

In the technology disclosed in Japanese Patent Application Laid-Open No. 5-268704, the driver is not required to step on the brake pedal during stopping on a sloping road, and accordingly the driver can easily start the vehicle on the sloping road. Therefore, drivability of the electric vehicle is improved. However, there arises a problem in that when the vehicle is kept at the stopping position by the torque motor for a long period, a quantity of the electric energy consumed in driving the motor becomes large to decrease the remaining electric capacity in a battery and to shorten the driving distance per single charge.

In the technology disclosed in Japanese Patent Application Laid-Open No. 7-322404, although position control is not performed, torque against moving downward of the vehicle is generated under a condition that neither the accelerator pedal nor the brake petal is stepped on. Therefore, if the driver always steps on the brake pedal. The motor does not need to output torque. However, it is not taken into consideration a case where the driver steps on the brake pedal with a weak force. Accordingly, there is a problem in that the electric vehicle may be moved downward on a sloping road when the driver steps on the brake pedal with a weak force.

Furthermore, in the technology disclosed in Japanese Patent Application Laid-Open No. 7-336807, although position control is not performed, occurrence of substantial local heat generation in the driving motor and the other electric power circuits is prevented by decreasing the torque command based on an accelerator opening when the vehicle is in a stall state exceeding an allowable period in the electric vehicle using a synchronous motor for the driving motor. However, in the technology, the torque command is decreased only when the accelerator pedal is being stepped on and the vehicle is in a stall state. Therefore, there arises a problem in that when the driver does not step on either of the accelerator pedal and the brake pedal, the electric vehicle is moved downward.

### SUMMARY OF THE INVENTION

In order to solve the above mentioned problems, a first object of the present invention is to provide an electric vehicle and a method of keeping the electric vehicle at a stopping position which can minimize required energy based on position control for keeping the electric vehicle not so as to be moved downward on a sloping road when a driver steps on the brake pedal even if the brake force is weak.

A second object of the present invention is to provide an electric vehicle and a method of keeping the electric vehicle at a stopping position which can minimize required energy based on position control by limiting a period of keeping the electric vehicle at a stopping position when the driver does not step on the brake pedal.

In order to attain the above object, an electric vehicle in accordance with the present invention is basically characterized by an electric vehicle keeping a vehicle body at a stopping position using rotating torque of an electric motor for driving the vehicle body to run, wherein the rotating torque is calculated corresponding to an operated quantity of brake operation, and the vehicle body is kept at the stopping position using the calculated rotating torque. In detail, an electric vehicle in accordance with the present invention is characterized by that when the brake pedal is stepped on under a condition that the vehicle body is at a stopping position by the rotating torque of the electric motor, the rotating torque is decreased and a quantity of motion of the electric vehicle, that is, a quantity of downward motion of the electric vehicle on a sloping road is measured, and the electric vehicle is again brought at the stopping position by the rotating torque when the quantity of downward motion of the electric vehicle exceeds a preset value.

In the electric vehicle in accordance with the present invention constructing as described above, when the brake pedal is stepped on under a condition that the vehicle body is at a stopping position by the rotating torque of the electric motor, the rotating torque is decreased and a quantity of downward motion of the electric vehicle on a sloping road is measured, and the electric vehicle is again brought at the stopping position by the rotating torque when the quantity of downward motion of the electric vehicle exceeds a preset value. Therefore, consumption of electric energy can be reduced by decreasing the rotating torque.

Another feature of the electric vehicle in accordance with the present invention is characterized by an electric vehicle keeping a vehicle body at a stopping position using rotating torque of an electric motor for driving the vehicle body to run, wherein a period to keep the vehicle body at the stopping position using rotating torque of the electric motor is a preset period after a brake pedal is stepped off.

Further, a preferable embodied feature of an electric vehicle in accordance with the present invention is characterized by that the preset period is a time required for a driver of the electric vehicle to change from stepping on the brake pedal to stepping on an accelerator pedal, and also characterized by that after elapsing the preset period, the rotating torque is gradually decreased.

Furthermore, another feature of an electric vehicle in accordance with the present invention is characterized by that an alarm for getting attention of a driver is given while the rotating torque is gradually being decreased.

Furthermore, another feature of an electric vehicle in accordance with the present invention is characterized by an electric vehicle keeping a vehicle body at a stopping position using rotating torque of an electric motor for driving the vehicle body to run, the electric vehicle comprising the electric motor; a control unit; a brake pedal and an oil hydraulic pressure brake device driven by the control unit, wherein the control unit keeps the vehicle body at the stopping position by the rotating torque of the electric motor for a preset period from the time when the brake pedal is off after the vehicle body is stopped by stepping on the brake pedal, and keeps the vehicle body at the stopping position by the oil hydraulic pressure brake device after elapsing the preset period.

In the another feature of the electric vehicle in accordance with the present invention constructing as described above, the period to keep the vehicle body at the stopping position using rotating torque of the electric motor is a preset period after a brake pedal is stepped off, and after elapsing the preset period, the rotating torque is decreased. Therefore, downward movement of the vehicle body due to decrease in the torque calls the driver's attention, and accordingly the driver steps on the brake pedal again. Thereby, consumption of electric energy can be reduced by decreasing the rotating torque.

Further, the period to keep the vehicle body at the stopping position using rotating torque of the electric motor is set to the time required for a driver of the electric vehicle to change from stepping on the brake pedal to stepping on an accelerator pedal. Therefore, during time required for the driver of the electric vehicle to change from stepping on the brake pedal to stepping on an accelerator pedal, the electric vehicle does not moved downward.

Further, the wheels are automatically locked by the oil hydraulic pressure brake. During stopping on a sloping road, the electric vehicle can be stopped on a sloping road without stepping on the brake pedal for a long time of the driver and without using a side brake, and without using the rotating torque of the motor. Therefore, the electric vehicle can be stopped on a sloping road without waste of electric energy.

### BRIEF DESCRIPTION OF THE DRAWINGS

FIG. 1 is a conceptual diagram showing the total construction of a first embodiment of an electric vehicle in accordance with the present invention.

FIG. 2 is a control diagram showing a torque command calculation part of the control unit of the electric vehicle of FIG. 1.

FIG. 3 is a flowchart of the processing of the torque command calculation part of FIG. 2.

FIG. 4 is a diagram showing an operating state of the electric vehicle of FIG. 1.

FIG. 5 is a diagram showing another operating state of the electric vehicle of FIG. 1.

FIG. 6 is a flowchart of the processing of the torque command calculation part of FIG. 2.

FIG. 7 is a diagram showing a further operating state of the electric vehicle of FIG. 1.

FIG. 8 is a diagram showing a still further operating state of the electric vehicle of FIG. 1.

FIG. 9 is a flowchart of the processing of the position control calculation part and the speed control calculation part of FIG. 2.

FIG. 10 is a flowchart of the processing of the torque decreasing part in the torque command calculation part of FIG. 2.

FIG. 11 is a flowchart of the processing of the preset period torque output part in the torque command calculation part of FIG. 2.

FIG. 12 is a conceptual diagram showing the total construction of a second embodiment of an electric vehicle in accordance with the present invention.

FIG. 13 is a control diagram showing the processing of the torque command calculation part in the control unit of the electric vehicle of FIG. 12.

FIG. 14 is a diagram showing an operating state of the electric vehicle of FIG. 12.

### DESCRIPTION OF THE PREFERRED EMBODIMENTS

An embodiment of an electric vehicle in accordance with the present invention will be described below in detail, referring to figures.

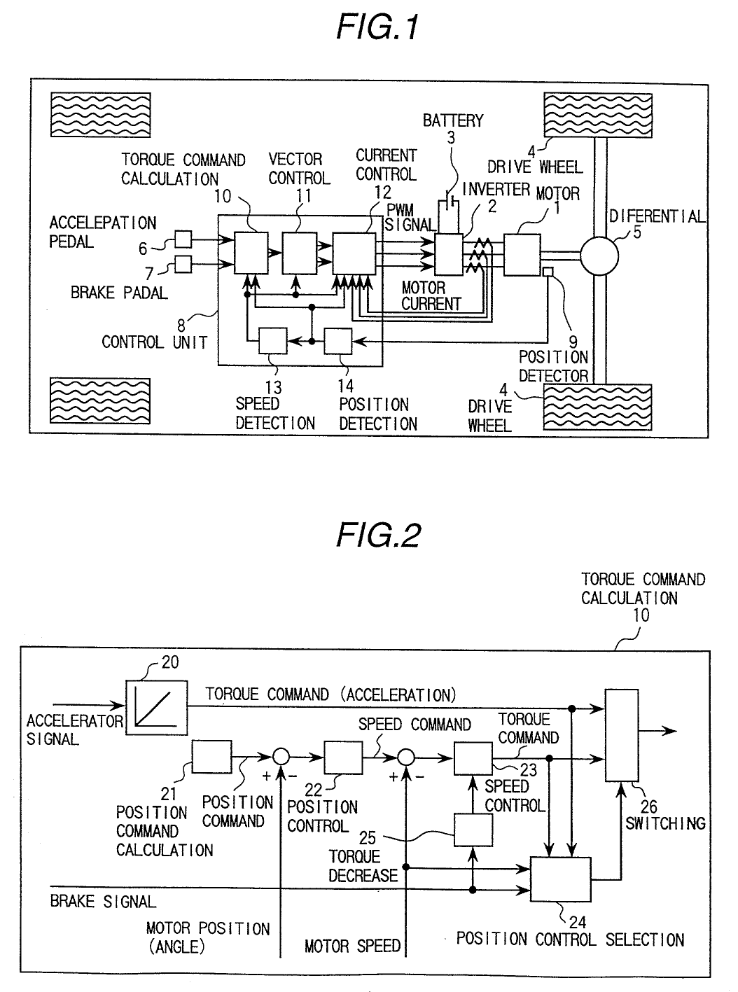

FIG. 1 is a conceptual diagram showing the total construction of a first embodiment of an electric vehicle in accordance with the present invention. The driving portion of the electric vehicle is composed of a permanent magnet synchronous motor 1, an inverter 2, a battery 3, driving wheels 4, a differential mechanism 5, an accelerator pedal 6, a brake pedal 7, a control unit 8 and a position detector 9, and the motor 1 is controlled by the three-phase inverter 2, and torque output from the motor 1 is transmitted to the driving wheels 4 through the differential mechanism 5 to run the vehicle body of the electric vehicle.

The inverter 2 converts energy of the battery 3 into three-phase alternating voltage using a PWM signal from the control unit 8 to drive the motor 1. The motor 1 may be an induction motor. Oil hydraulic brake devices, not shown, are provided to the four wheels, and a brake force can be generated in the wheel by stepping on the brake pedal 7.

The control unit 8 is composed of a torque command calculation part 10, a vector control part (current command calculation part) 11, a current control part 12, a speed detecting part 13 and a position detecting part 14, and the torque command calculation part 10 calculates a torque command for the motor 1. The vector control part 11 calculates or obtains by referring a preset table such a current command that an efficiency to a motor speed becomes maximum and torque generated by the motor becomes the torque command value. The current control part 12 performs current control calculation by feed back the motor current. The PWM signal is obtained by comparing the voltage command value obtained from the current control calculation and a carrier signal.

The position detection part 14 detects a position (angle) of the motor 1 from a signal of a position detector 9 attached to the motor 1. The position detector 9 outputs signals so as to detect a magnetic pole position and a motor angle. The position detecting part 14 detects a motor position by the signal from the position detector 9. The speed detecting part 13 detects a motor speed from number of changes in the motor position per unit time. Since the electric vehicle does not use a hydraulic torque transmission mechanism, the driving wheels 4 are stopped when the motor 1 is stopped.

FIG. 2 is a control diagram of the torque command calculation part 10 in the control unit 8. The torque command calculation part 10 receives input signals of an accelerator signal indicating an opening degree of the accelerator pedal, a brake signal indicating ON-OFF of the brake pedal, a motor position signal and a motor speed signal. The torque command calculation part 10 is composed of a torque command calculation part 20 for receiving the accelerator signal, a position command calculation part 21, a position control part 22, a speed control part 23, a speed control selection part 24, a torque decreasing part 25 and a torque command switching part 26.

The torque command calculation part 10 calculates a torque command from the accelerator signal when a driver normally drives by stepping on the accelerator pedal. The torque command calculation part 20 receiving the accelerator signal calculates a torque command proportional to the accelerator signal. When the electric vehicle is stopping on a sloping road and perform the position control, the torque command is calculated as follows.

Initially, the position control selection part 24 judges that the electric vehicle has been stopped, and judges based on a degrees of stepping of the accelerator pedal and the brake pedal at that time whether position control is performed or not. When the position control is performed, the position command calculation part 21 outputs a motor position at that time as a position command. Next, the position control pat 22 performs calculation of position control by checking the position command with the motor position at present time, and outputs a speed command. Further, the speed control part 23 performs calculation of speed control by checking the speed command with a motor speed at present time, and outputs a torque command.

The torque command switching part 26 outputs the torque command by the speed control calculation part 23 when the position control is selected. By using the position control mode, when the driver stops the electric vehicle on a sloping road and steps off the brake pedal (the brake pedal is brought in OFF state), the following operation is performed. That is, when the electric vehicle is stopped on the ascending road, a motor position at that time is stored as a position command. When the brake pedal is brought in OFF state by the driver, speed of the electric vehicle becomes negative and the vehicle body is moved downward. The position control part 22 calculates a positive speed command since the motor position becomes smaller than the position command, and the speed control part 23 outputs a positive torque command so that the motor speed agrees with the speed command. As a result, the electric vehicle is moved forward and is stopped when the electric vehicle returned to the original position.

The present embodiment is characterized by that the output torque command value can be decreased when the position control is performed corresponding to operation of the brake pedal, and the torque decreasing part 25 judges using the brake signal (the ON-OFF signal of the brake pedal) whether the brake pedal is stepped on or not and decreases the torque command to be calculated by the speed control part 23. Further, when the torque is decreased, an alarm is given to the driver.

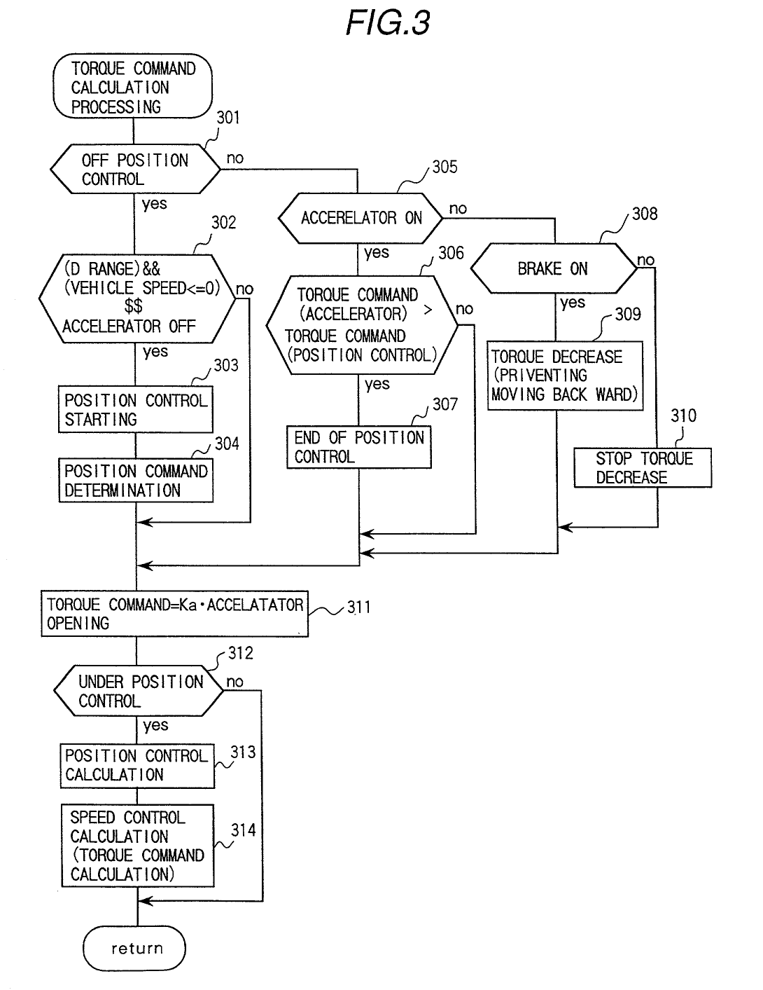

FIG. 3 is a flowchart of the processing of the torque command calculation part 10, and calculation of the flowchart is repeated every sampling time interval. In the torque command calculation processing, initially, it is judged in Step 301 whether the position control is being performed or not. If the position control is not being performed, the processing proceeds to Step 302, and it is judged whether present condition satisfies a condition to perform the position control or not. For example, in a case where a speed of the vehicle (or speed of the motor) is not larger than 0 (zero) when a shift position is in D (drive) range, and the accelerator is in OFF state, the processing enters in the position control of Step 303. Then, in Step 304, a position command of present motor position is determined. The condition that the processing enters in the position control when the speed of the vehicle (or speed of the motor) is not larger than 0 (zero) and the shift position is in D (drive) range may be changed to a condition that the processing enters in the position control when the speed of the vehicle (or speed of the motor) is not smaller than 0 (zero) and the shift position is in R (reverse) range, or condition that the processing enters in the position control when the speed of the vehicle (or speed of the motor) becomes 0 (zero) and the shift position is in D or R range.

In Step 301, if the position control is being performed, it is judged in Step 305 whether the acceleration pedal is stepped on or not. If the acceleration pedal is stepped on, in Step 306, magnitude of the torque command value calculated in the position control part is compared with the torque command value calculated from the accelerator signal. In Step 306, if the torque command value calculated from the accelerator signal is larger, the position control is ended in Step 307 since it is judged that the driver is about to drive the electric vehicle.

If it is judged in Step 305 that the acceleration pedal is not stepped on, the processing proceeds to Step 308 and it is judged whether the brake pedal is stepped on or not. If it is judged that the brake pedal is stepped on, the processing proceeds to Step 309 and torque decreasing processing (including backward moving preventing processing) is performed in Step 309. When it is judged that the brake pedal is stepped on, the torque command value calculated in the position control part is gradually decreased in the torque decreasing processing in Step 309 because it can be considered that the electric vehicle cannot be moved downward even if the rotating torque for the position control is decreased. The backward moving preventing processing is processing which can keep the electric vehicle at a stopping position by increasing the torque command value again if the electric vehicle is moved downward when the torque is being decreased.

That is, when the diver steps on the brake pedal too softly and the motor torque output for the position control becomes too small, the electric vehicle is moved downward. The backward moving preventing processing is for preventing this downward motion.

If it is judged in Step 308 that the brake signal is OFF, the processing proceeds to Step 310, and the above-mentioned processing for decreasing the torque is terminated and the electric vehicle is kept at the stopping position by the rotating torque of the motor.

Then, in Step 311, a torque command is calculated using the accelerator signal (Ka is a predetermined constant value), and the processing proceeds to Step 312. If it is judged in Step 312 that the position control is being performed, calculation for the position control is performed in Step 313, and calculation for the speed control is performed to calculate a torque command in Step 314. Under the condition that the position control is being performed, the torque command obtained from the speed control calculation has priority.

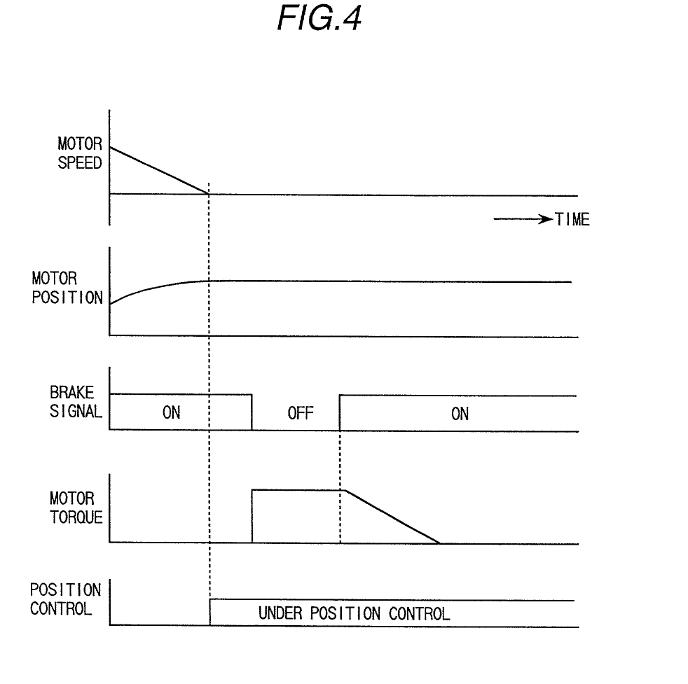

FIG. 4 is a diagram showing an operating state of the electric vehicle when it is controlled based on the flowchart shown in FIG. 3. When the electric vehicle is running forward on an ascending road (speed of the motor is positive), the electric vehicle stops by stepping on the brake pedal and the position control starts by the stopping. In this case, it is assumed that the accelerator pedal is not stepped on, which is not shown. Since the driver keeps surely stepping on the brake pedal, the motor position is not changed and motor torque is not output. When the brake pedal is brought to OFF state, motor torque is calculated and output by the position control because the motor position is changed. Therein, the changes in the motor torque and the motor speed are not shown because the changes are very small.

When the driver steps on the brake pedal again, the position control gradually decreases the motor torque. In this example, since the driver strongly steps on the brake pedal, the electric vehicle does not move backward even if the motor torque is decreased.

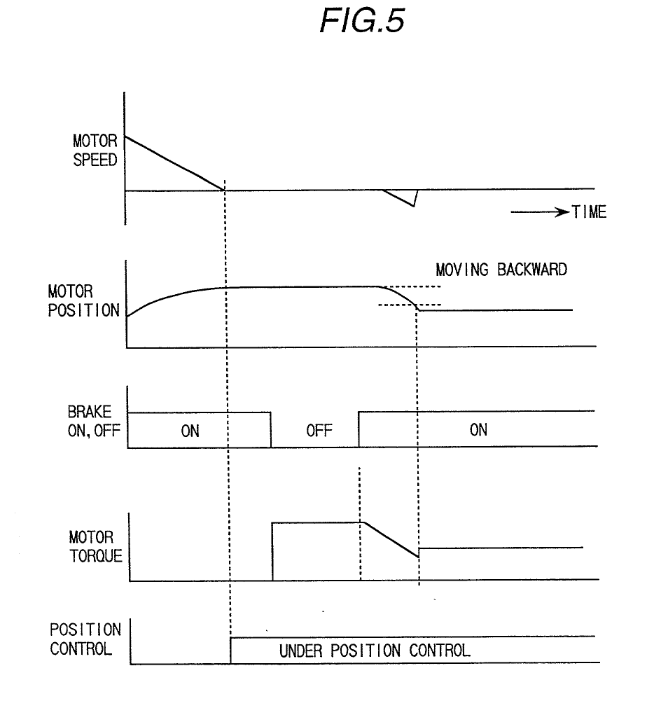

FIG. 5 shows operation of the electric vehicle similar to FIG. 4. When the driver steps on the brake pedal while the electric vehicle is running, the electric vehicle is stopped (the motor speed becomes zero) and at that time the position control starts. When the driver step off the brake pedal, motor torque calculated by the position control is output. When the driver steps on the brake pedal again, the position control starts to decrease the motor torque. When the brake pedal is insufficiently stepped, the electric vehicle is started to be moved downward due to decreasing of the motor torque. At that time, a quantity of the downward movement is detected from the motor position. If the quantity of the downward movement exceeds an allowable range (for example, approximately 5 cm on the basis of quantity of the downward movement of the electric vehicle), the motor torque decreasing process is stopped and the position control is restarted so as to keep the electric vehicle at the stopping position.

As a result, the electric vehicle is stopped and the necessary motor torque at that time is may be smaller than that when the driver does not step on the brake pedal. In this example, after the quantity of the downward movement of the electric vehicle exceeds an allowable range, the electric vehicle is kept at a position where the electric vehicle is moved downward (this is possible by changing the position command). However, the electric vehicle may be kept at a position where the electric vehicle has existed before being moved downward (the original position). By this method, energy consumption can be suppressed when the driver is stepping on the brake pedal.

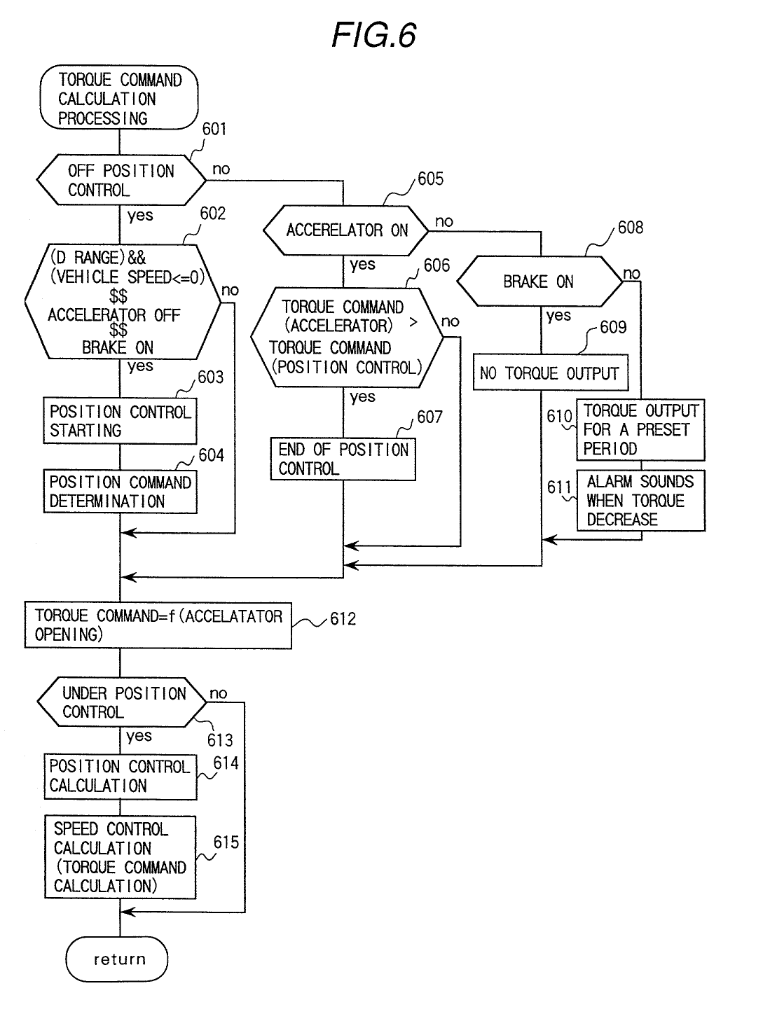

FIG. 6 is a flowchart of the processing of the torque command calculation part of FIG. 2, and calculation of the flowchart is repeated every sampling time interval. In the torque command calculation processing, initially, it is judged in Step 601 whether the position control is being performed or not. If the position control is not being performed, the processing proceeds to Step 602, and it is judged whether present condition satisfies a condition to perform the position control or not. For example, when a shift position is in D range, the processing proceeds to Step 603 to start the position control if three conditions that a speed of the vehicle is not larger than 0 (zero), that the accelerator is in OFF state, and that the brake pedal is not stepped on are satisfied. Then, in Step 604, a position command of present motor position is determined. Although in the above description, the position control is performed only when the shift position is in D range, the position control may be performed when the speed of the vehicle is not smaller than 0 (zero) and the shift position is in R (reverse) range, or when the speed of the vehicle (or speed of the motor) becomes 0 (zero) and the shift position is in D or R range.

In Step 601, if the position control is being performed, it is judged in Step 605 whether the acceleration pedal is stepped on or not. If the acceleration pedal is stepped on, magnitude of the torque command value calculated in the position control part is compared with the torque command value calculated from the accelerator signal. In Step 606, if the torque command value calculated from the accelerator signal is larger, the position control is ended in Step 607 since it is judged that the driver is about to drive the electric vehicle.

If it is judged in Step 605 that the acceleration pedal is not stepped on, the processing proceeds to Step 608 and it is judged whether the brake pedal is stepped on or not. If it is judged that the brake pedal is stepped on, the speed control part is set so as to not output a motor torque command in Step 609. When the electric vehicle is moved downward due to weak stepping on the brake pedal at that time, the electric vehicle does not move downward further if the driver is aware of it and strongly steps on the brake pedal. It is possible to provide a process for notify the driver of downward movement of the electric vehicle such as an alarm sound. If the brake pedal is in OFF state in Step 608, the processing proceeds to Step 610, and the position control is performed to keep the electric vehicle at the stopping position by the rotating torque of the motor. Therein, a period in which the rotating torque of the motor is being outputting is set to a preset time period from the time when the brake pedal is brought to OFF state. This preset time period is a time required for a driver of the electric vehicle to change from stepping on the brake pedal to stepping on an accelerator pedal when the driver steps on the accelerator pedal to start driving the electric vehicle from stopping state of the vehicle. For example, the preset time period is 5 seconds or shorter.

When the preset time elapses, the torque is gradually decreased in Step 610. When the torque is decreased, an alarm is sounded to notify the driver of decreasing of the rotating torque of the motor in Step 611. Instead of the alarm sound, the diver may be notified of it using an alarm by voice or flashing of an indicator in front of a driver seat. The alarm by voice will be, for example, “please, step on the brake pedal” or the like.

Then, a torque command is calculated using the accelerator signal in Step 612, and the processing proceeds to Step 613. If it is judged that the position control is being performed, calculation for the position control is performed in Step 614, and calculation for the speed control is performed to calculate a torque command in Step 615.

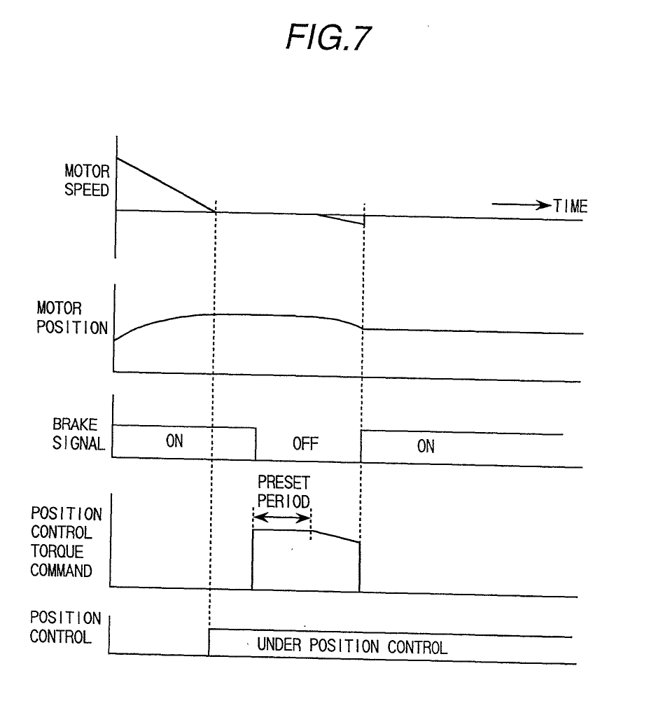

FIG. 7 is a diagram showing an operating state of the electric vehicle when it is controlled based on the flowchart shown in FIG. 6. When the electric vehicle is running forward on an ascending road (speed of the motor is positive), the electric vehicle stops by stepping on the brake pedal and the position control starts by the stopping. In this state, it is assumed that the accelerator pedal is not stepped on. Since the driver keeps stepping on the brake pedal, the motor position is not changed and motor torque is not output.

When the brake pedal is brought to OFF state, motor torque is output by the position control to keep the electric vehicle at the stopping position. When a preset time elapses after the brake pedal is OFF, the motor torque by the position control is gradually decreased. At that time, an alarm is sounded to the driver to step on the brake pedal. In FIG. 7, the electric vehicle is moved backward by decreasing the motor torque because the diver does not step on the brake pedal. The position control does not output the rotating torque of the motor. The electric vehicle is stopped by stepping of the driver on the brake pedal.

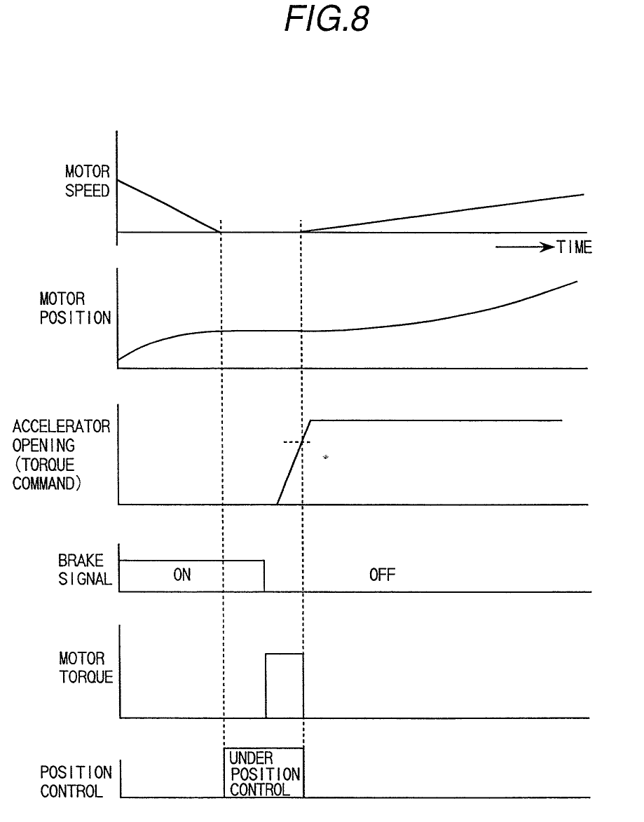

FIG. 8 shows operation of the electric vehicle similar to FIG. 7. When the driver steps on the brake pedal while the electric vehicle is running, the electric vehicle is stopped (the motor speed becomes zero) and at that time the position control starts. When the driver step off the brake pedal, motor torque calculated by the position control is output. When the driver steps on the accelerator pedal before decreasing of the motor torque after the preset time period, the position control is terminated at the time when the torque command of the accelerator signal exceeds the torque command of the position control, and the position control is switched to running by the torque command of the accelerator signal. This method can shorten the time period to consume energy by limiting the time period of outputting the rotating torque of the motor to the preset time period after stepping on the brake pedal.

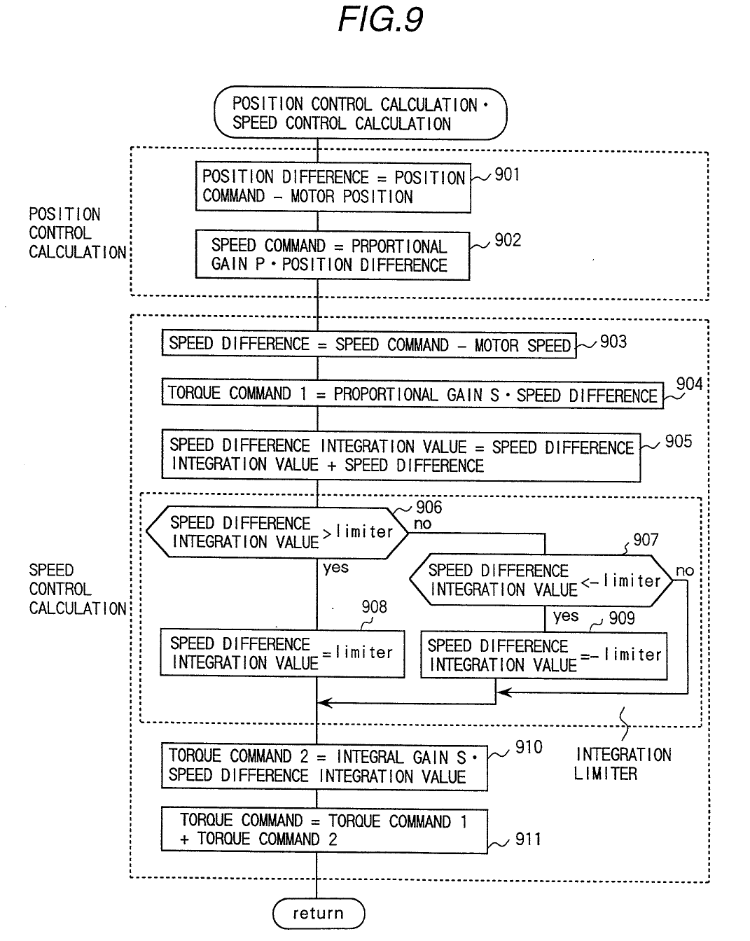

FIG. 9 is a flowchart of the processing of the position control calculation part and the speed control calculation part. Initially, a difference between a position command and a motor position (position difference) is calculated in Step 901, and a speed command is calculated by multiplying a proportional gain P to the position difference in Step 902. Here, the position control calculation is performed with proportional control. Next, the processing proceeds to Step 903 to calculate a difference between the speed command and a motor speed (speed difference), and a torque command 1 is calculated by multiplying a proportional gain S to the speed difference in Step 904.

Then, the speed difference is added to an integrated value of speed difference in Step 905, and the processing proceeds to Step 906. In Step 906 and Step 907, it is judged whether or not the integration value of speed difference exceeds a variable limiter expressing a maximum value of the integration value. If the integration value of speed difference exceeds the variable limiter, a value of the variable limiter is substituted into the integration value of speed difference in Step 908 and Step 909. A torque command 2 is calculated by multiplying the integration gain S to the integration value of speed difference in Step 910, and a torque command is calculated by adding the torque command 1 and the torque command 2 in Step 911. The speed control is performed with proportional and integral control, and the torque command 1 is a term for proportional control and the torque command 2 is a term for integral control. Although the proportional control is used for the position control calculation and the proportional and integral control is used for the speed control calculation, it is possible to employ a method that the proportional and integral control is used for the position control calculation and the proportional control is used for the speed control calculation.

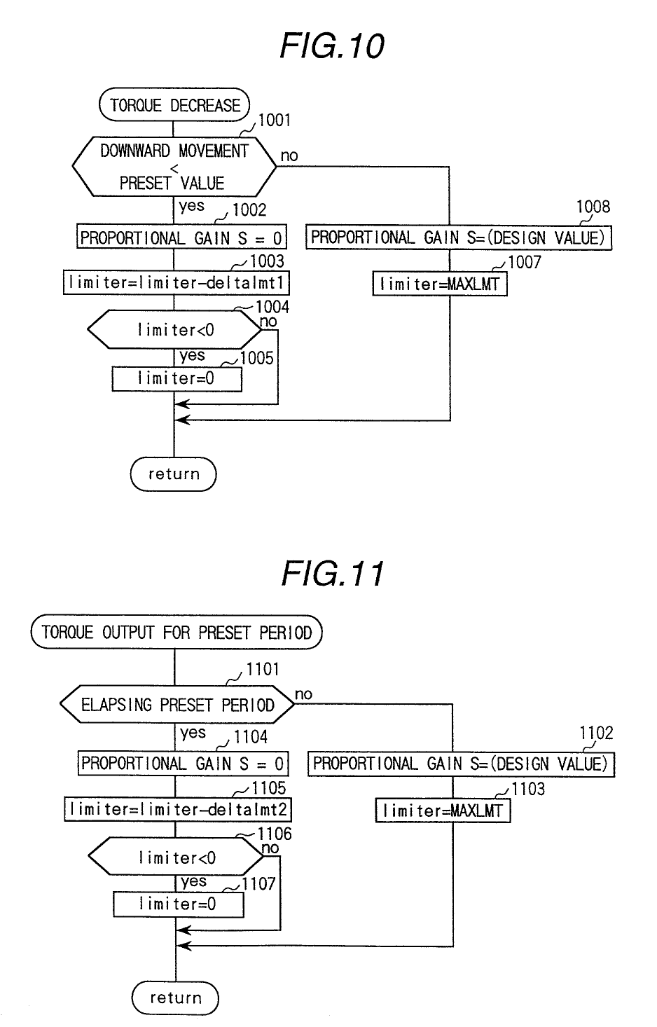

FIG. 10 is a detailed flowchart of the torque decreasing processing in Step 309 of the control flowchart of FIG. 3. This processing is performed when the brake pedal is stepped, and for gradually decreasing the motor torque command. The way to decrease the torque is to decrease the torque commands of the proportional control and the integral control in the speed control calculation part shown in FIG. 9.

In Step 1001, it is judged whether a downward movement is within the allowable range (preset value) or not. If the downward movement is within the allowable range, the proportional gain S is set to 0 (zero). Then in Step 1003, Step 1004 and Step 1005, a variable deltamt1 is subtracted from the variable limiter until the value of the variable limiter becomes 0 (zero). The value of the variable deltamt1 is designed so that the value of the variable limiter becomes 0 (zero) within about several hundreds milliseconds. Since the driver steps the brake pedal, the electric vehicle cannot be suddenly moved downward even if the torque is decreased fast.

If it is judged in Step 1005 that the downward movement exceeds the allowable range, the processing proceeds to Step 1006 and the proportional gain S is returned to an original design value. In Step 1007, the variable limiter is also returned to a value MAXLMT expressing the maximum value. The design value of the proportional gain S is predetermined from response of the speed control system. The value MAXLMT is predetermined from a maximum torque capable of being output. By this method, in a state in which the driver is stepping on the brake pedal after stopping the electric vehicle on a ascending road, the torque of the motor can be gradually decreased if the downward movement is within the allowable range, and the electric vehicle can be stopped at the stopping position if the downward movement exceeds the allowable range.

FIG. 11 is a detailed flowchart of the preset period torque outputting processing in Step 610 of the control flowchart of FIG. 6. This processing performs keeping of the electric vehicle at the stopping position by motor torque during the preset period from the time when the driver steps off the brake pedal, and gradually decreasing the motor torque after the time when the preset period elapses. The way to decrease the torque is to decrease the torque commands of the proportional control and the integral control in the speed control calculation part shown in FIG. 9.

In Step 1101, it is judged whether time after the brake pedal being OFF is smaller than the preset period or not. If the time is smaller than the preset period, the processing proceeds to Step 1102. In Step 1102, the proportional gain S is set to 0 (zero). Then in Step 1103, a variable limiter is set to a value MAXLMT expressing a maximum value. In Step 1105, Step 1106 and Step 1107, a variable deltamt2 is subtracted from the variable limiter until the value of the variable limiter becomes 0 (zero). The value of the variable deltamt2 is designed so that the value of the variable limiter becomes 0 (zero) within several seconds to several tens seconds.

In a state that the driver does not step on the brake pedal, it is dangerous to decrease the motor torque in a short time because the electric vehicle is suddenly moved backward. By the above-mentioned means, when the driver switches from a state of stepping on the brake pedal to a state of stepping off the brake pedal, the electric vehicle can be kept at the stopping position by motor torque during the preset period, and the motor torque can be gradually decreased after the time when the preset period elapses.

FIG. 12 is a diagram showing the total construction of another embodiment of an electric vehicle in accordance with the present invention. The electric vehicle is composed of a permanent magnet synchronous motor 1201, an inverter 1202, a battery 1203, driving wheels 1204, a differential mechanism 1205, an accelerator pedal 1206, a brake pedal 1207, a control unit 1208, a position detector 1209, a brake device drive unit 1215, brake devices 1216, 1217, 1218 and 1219.

The motor 1201 is controlled by the three-phase inverter 1202, and torque output from the motor 1201 is transmitted to the driving wheels 1204 through the differential mechanism 1205, and the electric vehicle runs by rotation of the driving wheels 1204. The inverter 1202 converts energy of the battery 1203 into three-phase alternating voltage using a PWM signal from the control unit 1208 to drive the motor 1201. Oil hydraulic brake devices, not shown, are provided to the four wheels including the driving wheels 1204, and a brake force can be generated in the wheel by stepping on the brake pedal 1207.

The control unit 1208 is composed of a torque command calculation part 1210, a vector control part (current command calculation part) 1211, a current control part 1212, a speed detecting part 1213 and a position detecting part 1214. The torque command calculation part 1210 calculates a torque command value. The vector control part 1211, the current control part 1212, the position detecting part 1214 and the speed detecting part 1213 operate similarly to the vector control part 11, the current control part 12, the position detecting part 14 and the speed detecting part 13 shown in FIG. 1, respectively.

Each of the brake devices 1216, 1217, 1218, 1219 pushes a brake pad onto a brake disk to stop rotation of the brake disk by a friction force. The brake device drive unit 1215 operates oil pressure of the brake devices based on a signal from the control unit 1208 to brake the drive wheels 1204. Although the brake in FIG. 12 is for stopping the driving wheels 1204, the brake may be for stopping the four wheels. Further, a common brake operated by stepping on the brake pedal 1207 may be used.

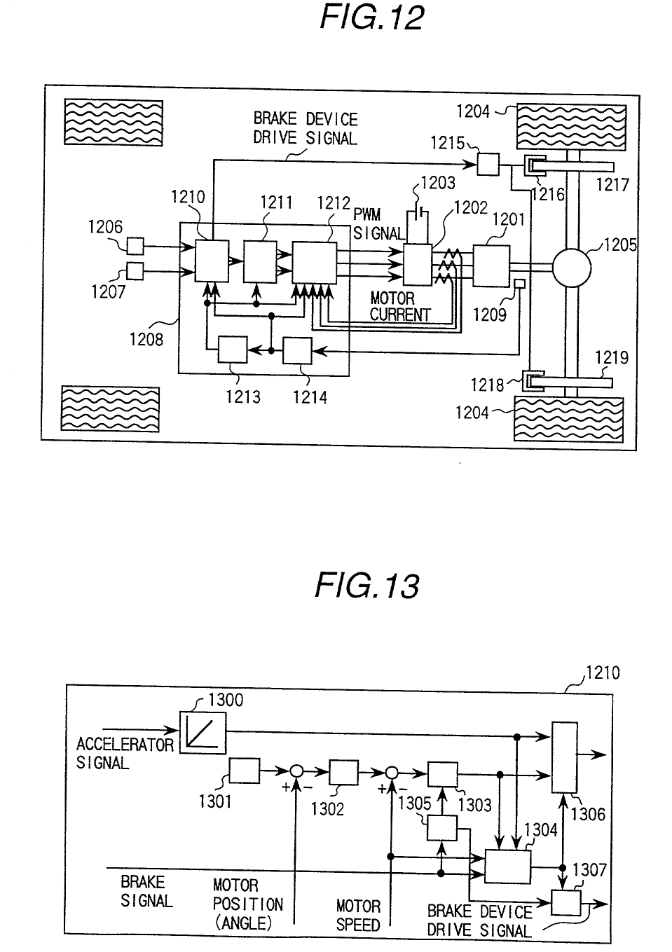

FIG. 13 is a detailed control diagram showing the torque command calculation part 1210 in the control unit 1208 of FIG. 12. The torque command calculation part 1210 receives input signals of an accelerator signal indicating an opening degree of the accelerator pedal, a brake signal indicating ON-OFF of the brake pedal, a motor position signal and a motor speed signal. The torque command calculation part 1210 is composed of a torque command calculation part 1300 receiving the accelerator signal, a position command calculation part 1301, a position control part 1302, a speed control part 1303, a speed control selection part 1304, a torque decreasing part 1305, a torque command switching part 1306 and a brake drive signal generating part 1307.

The torque command calculation part 1210 calculates a torque command from the accelerator signal when a driver normally drives by stepping on the accelerator pedal. The torque command calculation part 1300 receiving the accelerator signal calculates a torque command proportional to the accelerator signal.

When the electric vehicle is stopping on a sloping road and perform the position control, the torque command is calculated as follows. Initially, the position control selection part 1304 judges that the electric vehicle has been stopped, and the position control is performed if the accelerator pedal is stepped at that time. When the position control is performed, the position command calculation part 1301 outputs a motor position at that time as a position command.

Next, the position control pat 1302 performs calculation of position control by checking the position command with the motor position at present time, and outputs a speed command. Further, the speed control part 1303 performs calculation of speed control by checking the speed command with a motor speed at present time, and outputs a torque command. The torque command switching part 1306 outputs the torque command by the speed control calculation part 1303 when the position control is selected. The torque decreasing part 1305 judges from a brake signal (ON-OFF signal of a brake switch) whether or not the brake pedal is stepped on, and decreases the torque command calculated by the speed control part.

When the brake pedal is stepped on, the motor torque command is set to 0 (zero) so that the motor does not output torque. During a reset period from the time when the brake pedal is OFF, the torque command value by the speed control calculation part 1303 is output. After elapsing the reset period from the time when the brake pedal is OFF, a drive command signal is generated from the torque decreasing part 1305 to the brake drive signal generating part 1307. Thereby, the brake device drive signal is output from the brake drive signal generating part 1307. By this signal, the brake unit 1215 mechanically locks and stops the driving wheels 1204. When the driver steps on the accelerator pedal and terminates the position control, a signal from the position control selection part 1304 is output to the brake drive signal generating part 1307 to stop the output of the brake device drive signal and release the lock of the driving wheels 1204 by the brake unit 1215.

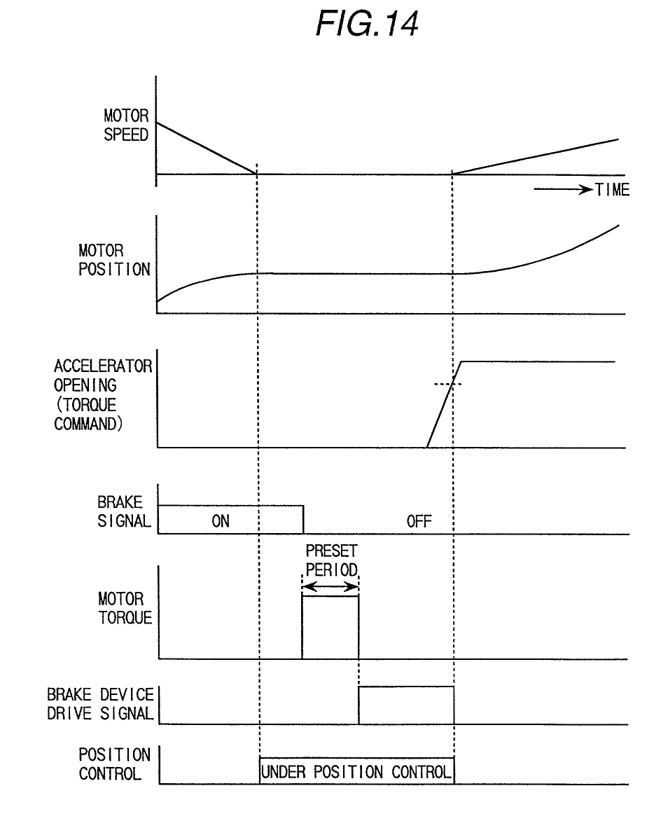

FIG. 14 is a diagram showing an operation of the electric vehicle controlled based on the control block diagram of FIG. 13 is used. When the electric vehicle is running forward on an ascending road (speed of the motor is positive), the electric vehicle stops by stepping on the brake pedal and the position control starts. In this state, since the driver steps on the brake pedal, motor torque is not output. When the brake pedal is brought to OFF state, motor torque is output by the position control to keep the electric vehicle at the stopping position. When a preset time elapses after the brake pedal is OFF, the driving wheels are braked by a brake device drive signal and the motor torque by the position control is brought to 0 (zero). When the driver steps on the accelerator pedal and the torque command by the accelerator signal exceeds the torque command when the position control is performed, the position control is terminated and switched to running by the torque command based on the accelerator signal.

It is considered to provide a means for storing a torque command value which has been necessary for performing the position control and determines an oil pressure at driving the brake devices based on the value. The means described above keeps the electric vehicle at the stopping position by the motor torque with performing the position control during a period in which a state of stepping on the brake pedal changes to a state of stepping on the accelerator pedal, and keeps the electric vehicle at the stopping position by a mechanical brake after the period. This embodiment needs to newly provide a brake drive unit, but the driver does not need to step on the brake pedal. Since the motor torque is not generated while a brake force is generated by the brake drive unit, consumption of energy is small.

Although the two embodiments in accordance with the present invention have been described above, it is to be understood that the present invention is not limited to the specific embodiments, and various changes may be resorted to without departing from the spirit and the scope of the invention as hereinafter claimed.

It can be understood from the above description that in a case where the electric vehicle in accordance with the present invention keeps the vehicle body at the stopping position using the rotating torque of the motor after stopping on a sloping road, consumption of required energy can be suppressed small by decreasing the rotating torque when the driver steps on the brake pedal. Further, since the vehicle body can be kept by the rotating torque during a period necessary for the driver to change stepping on the brake pedal to stepping on the accelerator pedal, the electric vehicle can be prevented from moving downward at starting on a sloping road.

What is claimed is:

1. An electric vehicle keeping a vehicle body at a stopping position using rotating torque of an electric motor for driving the vehicle body to run, wherein said rotating torque is calculated corresponding to an operated quantity of brake operation, and the vehicle body is kept at the stopping position using the calculated rotating torque.

2. An electric vehicle keeping a vehicle body at a stopping position using rotating torque of an electric motor for driving the vehicle body to run when a brake pedal is stepped on, wherein said rotating torque is calculated corresponding to an operated quantity of the brake pedal, and the vehicle body is kept at the stopping position by generating the calculated rotating torque in the electric motor.

3. An electric vehicle according to any one of claim 1 and claim 2, wherein when the brake pedal is stepped on under a condition that the vehicle body is at a stopping position by the rotating torque of the electric motor, the rotating torque is decreased and a quantity of motion of the electric vehicle is measured, and the electric vehicle is again brought at the stopping position by the rotating torque when said quantity of motion exceeds a preset value.

4. An electric vehicle keeping a vehicle body at a stopping position using rotating torque of an electric motor for driving the vehicle body to run, wherein a period to keep the vehicle body at the stopping position using rotating torque of the electric motor is a preset period after a brake pedal is stepped off.

5. An electric vehicle according to claim 4, wherein said preset period is a time required for a driver of said electric vehicle to change from stepping on the brake pedal to stepping on an accelerator pedal.

6. An electric vehicle according to claim 4, wherein after elapsing said preset period, said rotating torque is gradually decreased.

7. An electric vehicle according to claim 6, wherein an alarm for getting attention of a driver is given while said rotating torque is gradually being decreased.

8. An electric vehicle keeping a vehicle body at a stopping position using rotating torque of an electric motor for driving the vehicle body to run, said electric vehicle comprising the electric motor; a control unit; a brake pedal and an oil hydraulic pressure brake device driven by said control unit, wherein said control unit keeps the vehicle body at the stopping position by the rotating torque of said electric motor for a preset period from the time when said brake pedal is off after the vehicle body is stopped by stepping on said brake pedal, and keeps the vehicle body at the stopping position by the oil hydraulic pressure brake device after elapsing said preset period.

9. A method of keeping an electric vehicle at a stopping position using rotating torque of an electric motor for driving the vehicle body to run when a brake pedal is stepped on, wherein said rotating torque is calculated corresponding to an operated quantity of the brake pedal, and the vehicle body is kept at the stopping position by generating the calculated rotating torque in the electric motor.

10. A method of keeping an electric vehicle at a stopping position according to claim 9, wherein when the brake pedal is stepped off and again stepped on under a condition that the vehicle body is at the stopping position by the rotating torque of the electric motor, the rotating torque is decreased and a quantity of downward motion of the electric vehicle on a sloping road is measured, and the electric vehicle is again brought at the stopping position by the rotating torque when said quantity of downward motion of the electric vehicle exceeds a preset value.
